(19) United States
(12) Patent Application Publication
(10) Pub. No.: US 2013/0292888 A1
(43) Pub. Date: Nov. 7, 2013

(54) AIR DAMPING MOUNT

(71) Applicants: HYUNDAI MOTOR COMPANY, Seoul (KR); KIA MOTORS CORPORATION, Seoul (KR); PYUNG HWA INDUSTRIAL CO. LTD., Daegu (KR)

(72) Inventors: Dong-Jin Hwang, Seoul (KR); Jong-Su PARK, Daegu (KR); Young-Dal KIM, Daegu (KR)

(73) Assignees: Hyundai Motor Company, Seoul (KR); Pyung Hwa Industrial Co. Ltd., Daegu (KR); Kia Motors Corporation, Seoul (KR)

(21) Appl. No.: 13/751,893

(22) Filed: Jan. 28, 2013

(30) Foreign Application Priority Data
May 4, 2012 (KR) 10-2012-47291

(51) Int. Cl. F16F 13/08

(52) U.S. Cl. CPC F16F 13/08
USPC 267/140.13

(57) ABSTRACT

An air damping mount includes: a housing in which a space is formed and an upper part of which is shielded by a cover; an insulator embedded in the housing forming first and second chambers at a lower and upper parts, respectively, and elastically deformed in accordance to the load applied thereto; and a core coupled to the insulator embedded in the housing and coupled to an engine through a hanger bracket protruding externally to a side direction of the housing wherein a first air hole is punched for air to enter into and exit from the first chamber and a second air hole is punched for air to enter into and exit from the second chamber. The chambers which air enter into and exit from are formed at an upper part and a lower part of the housing to improve noise, vibration and harshness (NVH).

### CROSS-REFERENCE TO RELATED APPLICATION

The present application claims priority of Korean Patent Application Number 10-2012-47291 filed May 4, 2012, the entire contents of which application is incorporated herein for all purposes by this reference.

### BACKGROUND OF INVENTION

1. Field of Invention

The present disclosure relates to a damping mount, and more particularly, to an air damping mount of a hanger type, capable of improving static property and dynamic property and suppressing a creep phenomenon by including chambers at two locations.

2. Description of Related Art

Generally, a vehicle engine produces vibration after starting and thus it is rested on a damping mount to be mounted to a vehicle body when the vehicle engine is mounted. Accordingly, the damping mount has been developed for aiming to suppress vibration of a power train formed by connecting an engine, a transmission and a power transferring system.

A damping mount of a vehicle may be classified as a rubber mount for damping vibration using elastic force of rubber, an air damping mount (pneumatic type mount) for damping vibration using air as operation fluid through air entry and exit and a hydro mount (fluid sealed type mount) using liquid as an operation fluid.

The mounts are mounted around an engine compartment in which a power train is seated to support a load of the power train (specially, engine and transmission), and the inner part thereof is shown in FIGS. 1A, 1B and 1C.

Referring to FIGS. 1A, 1B and 1C, a rubber mount is mounted in such a manner that a center bolt to which an engine (or transmission) is coupled protrudes upward in a housing wherein the center bolt is mounted within the housing together with a core and a rubber. Here, vibration transferred trough the center bolt is dampened through an elastic deformation of the rubber.

Meanwhile, in a case of a hydro mount, a center bolt, a core, a rubber, a nozzle plate and a diaphragm are mounted within a housing wherein an upper chamber and a lower chamber are formed on an upper part and a lower part of the nozzle plate, respectively. Here, a predetermined amount of hydro liquid is filled in the chambers wherein the fluid damps vibration (transferred from the engine) in accordance to the elastic deformation of the rubber while flowing between the upper chamber and the lower chamber through a flow channel formed in a ring shape along a circumference of the nozzle plate. At this time, a membrane is arranged additionally to be vibrated in accordance to the flow of the hydro liquid to damp more efficiently the vibration in a high frequency region.

The rubber mount is low price but a damping effect is not good whereas the hydro mount has more efficient damping effect but it requires more components to increase a manufacturing cost.

The air damping mount has generally intermediate manufacturing cost and damping efficiency between the rubber mount and the hydro mount. The air damping mount is provided with a lower plate to form an air chamber at a lower part of the rubber, having a predetermined volume wherein air enters into the air chamber and exits therefrom (through air hole punched to the lower plate) in accordance to the elastic deformation. That is, the damping effect is made by the rubber elastic deformation and air flow variation.

Accordingly, the air damping mount uses air as an operation fluid and thus has lower vibration control performance comparing to the hydro mount but high vibration control performance comparing to the rubber mount (operated using the elastic force without the operation fluid). Further, the air damping mount has a simple configuration of a flow channel through which the operation fluid flows and thus can be manufactured easily and has advantageous effects over the hydro mount in terms of cost and weigh to obtain good performance comparing to cost and weigh when it is used to a small car.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention has been proposed to solve the above drawbacks. Various aspects of the present invention provide for an air damping mount that is mounted to a vehicle body and supports a load of an engine, including: a housing in which a space is formed and an upper part of which is shielded by a cover; an insulator that is embedded in the housing such that a first chamber is formed at a lower part and a second chamber is formed at an upper part, and is elastically deformed in accordance to the load applied thereto; and a core coupled to the insulator that is embedded in the housing and coupled to an engine through a hanger bracket protruding externally to a side direction of the housing wherein a first air hole is punched for air to enter into and exit from the first chamber and a second air hole is punched for air to enter into and exit from the second chamber.

A protrusion protruding upward may be formed in the cover to form the second chamber and the second air hole may be formed on an outer peripheral surface in a side direction of the protrusion.

The insulator may be mounted within the housing while having enlarging portions diameters of which are enlarged at an upper part and lower part, respectively, wherein ring plates may be coupled to the remote ends of the enlarging portions, respectively.

The lower enlarging portion of the insulator may be mounted to form a bridge angle with respect to a bottom surface of the housing wherein the bridge angle may be set as a range of 25-35°.

Sealings may be mounted between the insulator and the enlarging portions to maintain air-tightness.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIGS. 1A, 1B and 1C are partly cutaway view and sectional view illustrating inner structures a rubber mount, a hydro mount and a conventional air damping mount, respectively;

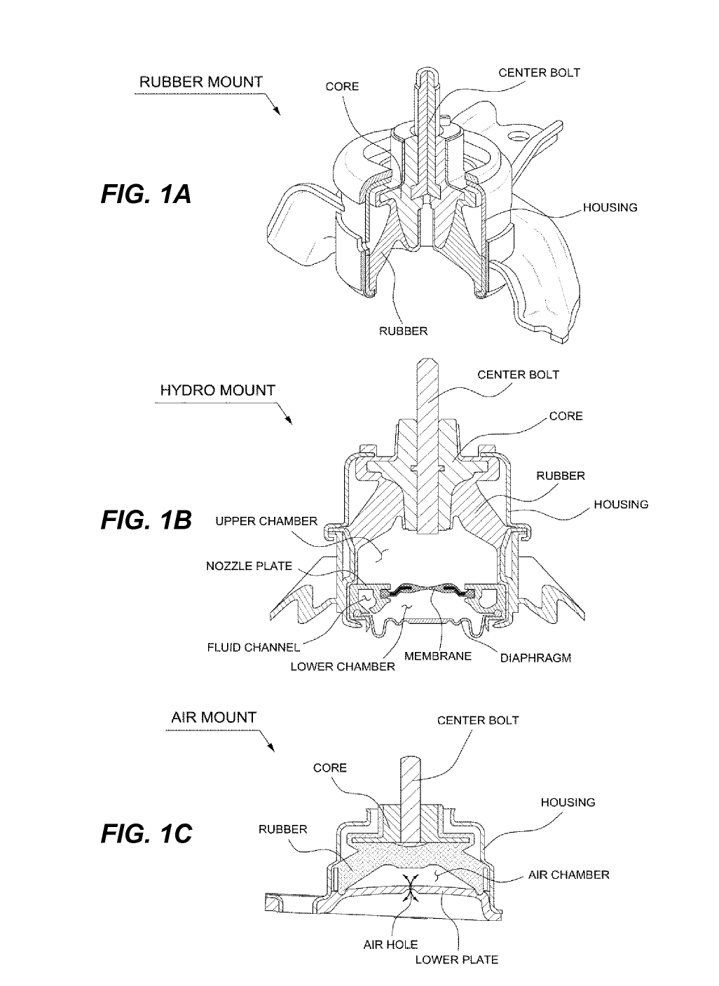

FIG. 2 are perspective views illustrating an exemplary air damping mount according to the present invention and the air damping mount mounted to a vehicle, respectively;

FIG. 3 is a sectional view taken along line A-A of FIG. 2;

FIG. 4 are perspective view and partly enlarged view illustrating an exemplary air damping mount according to the present invention, respectively.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

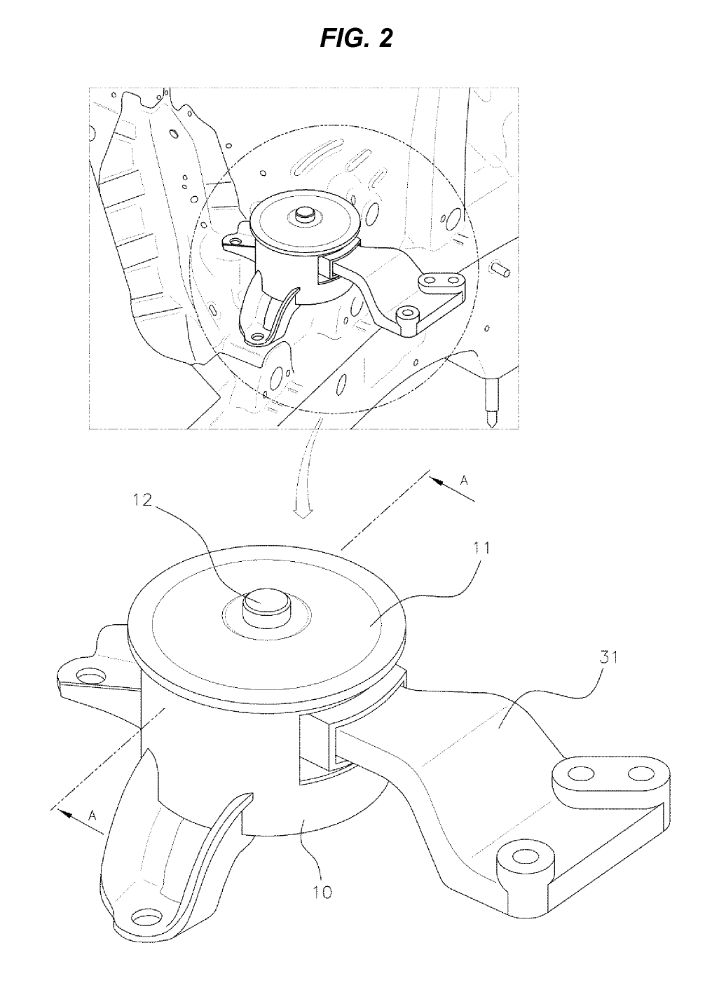

As shown in FIG. 2, an air damping mount is mounted to a vehicle body provided with a compartment of an engine wherein a hanger bracket 31 on which the engine is rested protrudes toward a side direction of the housing 10.

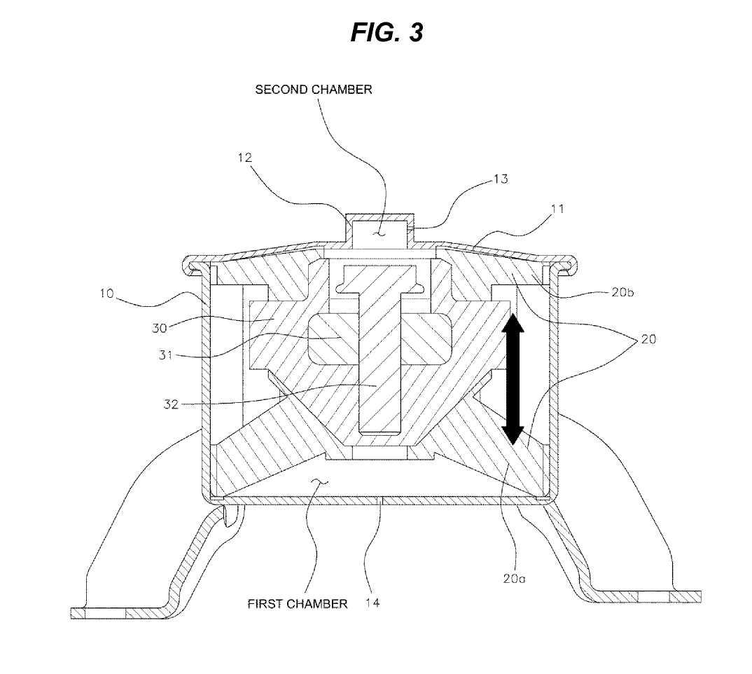

Referring to FIG. 3, the hanger bracket is coupled to a lower part of the housing 10 by a welding and spaced from a vehicle body wherein a predetermined space is formed in the housing and a cover 11 is coupled to an upper part of the housing.

An insulator 20 coupled with a core 30, which is made of rubber or synthetic resin material to be deformed elastically, is mounted in the housing 10. The insulator 20 is provided with enlarging portions 20a, 20b at an upper part and a lower part of the housing, respectively, to form a first chamber and a second chamber in the housing 10. The core 30 is coupled integrally to a part between the upper enlarging portion 20b and the lower enlarging portion 20a. The core 30 is coupled to the hanger bracket 31 that protrudes toward a side direction of the housing 10 through a fastening bolt 32. Accordingly, the first chamber and the second chamber are formed at an upper part and a lower part in the housing 10.

The second chamber is formed at an inside of a protrusion 12 that protrudes upward from the cover 11 (and a gap formed over the upper enlarging portion). Further, a first air hole 14 is formed on a lower part of the housing 10 and a second air hole 13 is punched to an outer peripheral surface of the protrusion 12 so that air can enter into and exits from the first and second chambers in accordance to elastic deformation of the insulator 20 (caused from a movement of the engine). The second air hole 13 may be formed at an upper part of the protrusion but it may be formed at a side of the protrusion to prevent moisture or foreign substance from infiltrating into the second chamber.

As described-above, the insulator 20 is formed with the enlarging portions 20b, 20a, which have enlarged diameters at an upper part and a lower part, respectively, to be mounted within the housing 10 wherein ring plates 40b, 40a are coupled to the remote ends of the respective upper enlarging portion 20b and the lower enlarging portion 20a. The ring plates 40a, 40b are made of metal material with strong resist-abrasion and may be formed separately and coupled to the insulator 10. In various embodiments, the ring plates may be curing-molded integrally with the insulator in order to improve air-tightness when the insulator is manufactured. One will also appreciate that the ring plates may be monolithcally formed with the insulator.

Meanwhile, the lower enlarging portion 20a of the insulator is mounted to form a bridge angle with respect to a bottom surface of the housing 10 wherein the bridge angle may be a range of approximately 25 to 35°, and more preferably approximately 30°, in considering of the slack amount of the insulator 20 (a lowering length of the core in case where the insulator is elastically deformed downward) when a load of an engine is transferred. The insulator 20 has elastic force such that the slack amount thereof is a range of approximately 4 to 6 mm, and more preferably approximately 5 mm, when an engine is mounted.

Meanwhile, in the air damping mount according to the present invention, the volume of the first chamber is larger than that of the second chamber. Accordingly, a sealing 50 may be arranged alternatively on a lower part of the housing 10 to improve further air-tightness before the lower ring plate 40a the insulator 20 are press-entered.

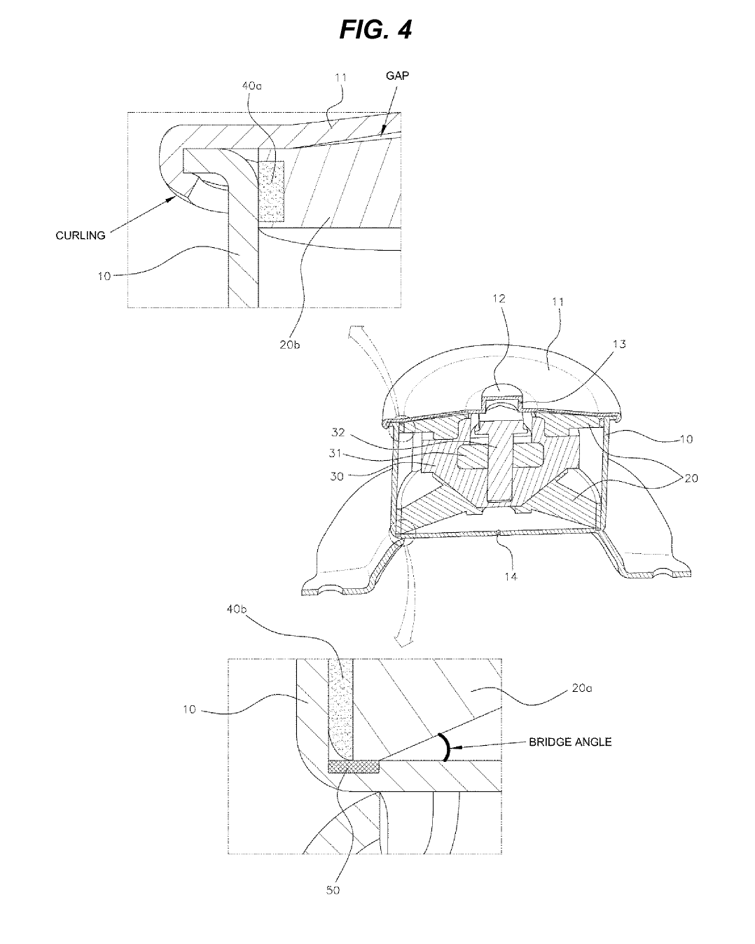

Furthermore, the insulator 20 is fabricated such that the upper enlarging portion 20b is in close contact with the cover 11, and a gap is formed by a load when an engine is rested (see FIG. 4). The gap is communicated to the second chamber so that the volumes are varied by the elastic deformation of the insulator 20 due to the load of an engine, respectively, to produce damping force with air flow in accordance to variations of the volumes. A frequency band of a peak value may be tuned by adjusting the diameters of the first air hole 14 and the second air hole 13. For example, when the diameters become smaller, the frequency band of the peak value moves to a low frequency band, and when the diameters become greater, the frequency of the peak moves to a high frequency band.

Further, the damping property may be tuned by adjusting a size and a location and/or increasing the number of the protrusion 12. Accordingly, wider design freedom degree can be provided when the air damping mount is designed.

According to the present invention, the chambers which air enter into and exit from are formed at an upper part and a lower part of the housing to improve noise, vibration and harshness (NVH).

Furthermore, an engine is rested through a hanger bracket for a fastening height between the engine and the mount to be lowered comparing to a prior art thereby improving stability of a vehicle body and ensuring strength.

The enlarging portion a diameter of which is enlarged is formed on the insulator to be in close contact with the inside of the housing wherein the ring plate of metal material is coupled to prevent abrasion and creep produced from the insulator made of rubber (or synthetic resin).

The sealing is mounted between the ring plate of metal material and the housing to maintain air-tightness of the insulator.

Further, tuning factors about a slope of the bridge angle and/or volume variation of the first chamber or the second chamber are provided to provide wider design freedom degree to a designer.

For convenience in explanation and accurate definition in the appended claims, the terms upper or lower, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An air damping mount that is mounted to a vehicle body and supports a load of an engine, comprising:
a housing in which a space is formed and an upper part of which is shielded by a cover;
an insulator that is embedded in the housing such that a first chamber is formed at a lower part and a second chamber is formed at an upper part, and is elastically deformed in accordance to the load applied thereto; and
a core coupled to the insulator that is embedded in the housing and coupled to an engine through a hanger bracket protruding externally to a side direction of the housing wherein a first air hole is punched for air to enter into and exit from the first chamber and a second air hole is punched for air to enter into and exit from the second chamber.

2. The air damping amount of claim 1, wherein a protrusion protruding upward is formed in the cover to form the second chamber and the second air hole is formed on an outer peripheral surface in a side direction of the protrusion.

3. The air damping mount of claim 1, wherein the insulator is mounted within the housing while having enlarging portions diameters of which are enlarged at an upper part and lower part, respectively, wherein ring plates are coupled to the remote ends of the enlarging portions, respectively.

4. The air damping mount of claim 3, wherein the lower enlarging portion of the insulator is mounted to form a bridge angle with respect to a bottom surface of the housing wherein the bridge angle is set as a range of 25-35°.

5. The air damping mount of claim 3, wherein sealings are mounted between the insulator and the enlarging portions to maintain air-tightness.

6. The air damping mount of claim 4, wherein sealings are mounted between the insulator and the enlarging portions to maintain air-tightness.
